(19) United States
(12) Patent Application Publication
(10) Pub. No.: US 2006/0284393 A1
(43) Pub. Date: Dec. 21, 2006

(54) Truck bed design for automotive and equipment delivery

(75) Inventors: Raymond Smith JR., Lake Bluff, IL (US); Joseph Simons, Oconomowoc, WI (US); Philip Simons, Oconomowoc, WI (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Up-N-Atom, Inc.

(21) Appl. No.: 11/454,289

(22) Filed: Jun. 16, 2006

Related U.S. Application Data
(63) Continuation-in-part of application No. 10/751,177, filed on Jan. 2, 2004, now Pat. No. 7,063,494.
Application No. 10/751,177 is a continuation-in-part of application No. 09/818,446, filed on Mar. 27, 2001, now Pat. No. 6,698,996.
(60) Provisional application No. 60/192,961, filed on Mar. 29, 2000.

(51) Int. Cl. B62D 17/00

(52) U.S. Cl. 280/86.751

(57) ABSTRACT

The present invention is directed to a specialized truck bed wherein the bed is divided into two areas or deck sections connected by a transverse hinge. The invention is also directed to a winch system for use on a vehicle. The invention is further directed to an improved locking post or post assembly for use with the specialized truck bed of the present invention.

This application is a continuation-in-part of co-pending application Ser. No. 10/751,177 filed Jan. 4, 2004 which is a continuation-in-part of application Ser. No. 09/818,446 filed Dec. 27, 2001 (New U.S. Pat. No. 6,698,996 issued Mar. 2, 2004) which claims the benefit of provisional application 60/192,961 filed Mar. 29, 2000.

The present invention relates to truck beds for automobile and equipment delivery, and more specifically to a truck bed which is divided into two areas and connected by a hinge. Even more specifically, the present invention is directed to such a truck bed with an improved post assembly or locking post design.

Distributors of construction related rental equipment are daily confronted with the task of reducing the cost of single unit equipment delivery to the end user. Many are forced to use large tractors and trailers or heavy duty trucks equipped with roll back beds, which have been purchased to haul the bulkiest equipment in their rental fleets, for delivery of very small units. This has made the single delivery of a small unit very costly to the distributor since he cannot pass on the full expense to his customer. To reduce costs, the distributor will sometimes load a large trailer with a number of pieces of equipment, each destined for delivery to a different site. By following this practice, only one customer will receive his order in a timely fashion. The rest will have to wait.

An alternative method requires that the distributor own one or several small trailers towed by heavy duty pick-up trucks to make these deliveries. Even a small truck-trailer combination is quite long and difficult to maneuver for all but a skilled operator, especially in crowded city traffic. Delivery on muddy construction sites with such truck-trailer combinations is extremely difficult, especially when backing up to a drop off site is required.

The present invention is intended to overcome these shortcomings.

### SUMMARY OF THE INVENTION

The present invention is directed to a specialized truck bed wherein the bed is divided into two areas or decks connected by a transverse hinge.

In one embodiment of the present invention, each deck section of the bed is constructed in an arch. The result is a light weight bed of great strength without need for a number of heavy gauge cross pieces as is typical in conventional flat bed design. An additional benefit of this design is that the resultant lowered center of gravity of both the bed and the load provides improved handling and a sense of greater stability for the driver.

In another embodiment, when in the travel position, the arch of the rear deck is slightly higher than that of the front. The benefit of this feature is that no significant hump occurs at the hinge line when the rear deck is lowered for ground loading and unloading. This allows very easy loading of any equipment with low ground clearance without fear of bottoming out on the hinge when crossing from the rear to the front portion of the deck.

In another embodiment, the rear deck-ramp combination of the present invention creates a very gentle grade, low enough to allow most powered equipment to readily climb onto the deck without assistance from a winch, thus reducing the cost of loading by saving time and labor.

In still yet another embodiment, the front deck portion is firmly fixed to the truck frame with conventional “U” bolts and shear plates. In the travel position, the hinge mounted rear deck is carried on two posts whose top ends are mounted to the deck frame while the slotted bottom end rests in truck frame mounted pins. The rear deck can be moved through an arc by a frame mounted elevating device such as an air or hydraulic cylinder, or by a powered screw. Ideally, the elevating device does not carry any load while the bed is in the travel position. This movement allows the rear deck to be raised for loading and unloading to an elevated dock, or lowered for loading and unloading directly to the ground. The rear deck also has a storage apparatus for ramps. These are used as a length addition to the lowered rear deck for ground loading and unloading. The rear deck-ramp combination creates a very gentle grade, low enough to allow most powered equipment to readily climb onto the deck without assistance from a winch, thus saving labor and time in loading the truck bed.

In a further embodiment, the truck bed has a winch which can be fitted to a cross tube assembly at the front of the deck. This tube assembly has a number of equally spaced slots along its front edge to engage a shot pin on the winch carrier for locking the winch against sideways movement when it is being used to assist in loading. This locking feature is especially beneficial when loading narrow equipment where two or more can be loaded side by side. In those cases, the movable winch can be positioned so that its cable will pull each piece of equipment onto the deck in a straight line. The present invention also encompasses this winch in other types of truck beds.

In still a further embodiment, the bed is fitted with numerous chain hold down points across the front and back, and along both sides.

In yet another embodiment of the present invention, the truck bed of the present invention has an improved and simplified post assembly or locking post design. This improved post assembly reduces the cost of the post assembly in the embodiments described above. In a further embodiment, the post assembly is provided with a notched dock lock to support the rear deck of the truck bed at a height convenient for loading or unloading equipment from a commercial truck dock.

Another embodiment of the present invention is directed to a truck or vehicle comprising a frame, and a bed located on said frame, said bed comprising a substantially flat front deck portion, a rear deck portion, and a hinge connecting said substantially flat front deck portion and said rear deck portion, wherein said rear deck portion arches upward toward said hinge, so that said rear deck portion has a continuous convex curve shape over said frame.

Another embodiment of the present invention is directed to a bed for a truck or vehicle comprising a cross beam hinge support fastened to the frame of the truck, with a pivot/hinge; a rear deck portion; and a pivot pin connecting said rear deck portion to said cross beam hinge support. Preferably, the rear deck portion arches upward toward said pivot/hinge area, so that said bed has a continuous convex curve shape over said frame. Additionally, the bed can include a front deck portion, wherein the front deck portion and the rear deck portion are connected to the cross beam hinge support by transverse hinge pins so that the front and rear deck portion arch upward towards the area above the hinge pins and cross beam hinge support, thus forming a continuous convex curve over said truck frame, or vehicle frame. Additionally, a deck extension panel with supports for hinges can be substituted for the cross beam hinge support. Preferably, the deck extension panel is firmly fastened to truck frame or vehicle frame. Preferably, the front deck portion and rear deck portion are connected to the deck extension panel by transverse hinge pins thus forming an extended bed wherein the front deck portion, and rear deck portions arch upward toward the area above the hinge pins, and the deck extension panel.

Another embodiment of the present invention is directed to a truck comprising a frame, and a bed located on said frame, said bed comprising a front deck portion, a rear deck portion, and a hinge connecting said front deck portion and said rear deck portion, wherein each of said front deck portion and said rear deck portion angles upward toward said hinge, so that said front and rear bed portion has at least 3 angular segments to approximate a continuous convex curve shape over said frame.

### BRIEF DESCRIPTION OF THE DRAWINGS

In describing the preferred embodiments, reference is made to the accompanying drawings wherein:

FIG. 1 shows an unloaded truck with the truck bed of the present invention in a travel position.

FIG. 2 shows ramps lowered to the ground from the storage area in the rear bed portion of the truck bed of the present invention.

FIG. 3A shows the lip of the door to the storage area of the rear bed portion of the truck bed supporting a hook end of a ramp.

FIG. 3B shows the access door of the rear bed portion of the truck bed closed and securely locking the hook end of the ramp against removal or disengagement during loading.

FIG. 4 shows the ramps positioned laterally from a central storage position and being securely locked and ready for loading.

FIG. 5 shows the truck bed and ramp combination of the present invention with the truck bed partially lowered where, for example, it is mounted to a truck with a voided air suspension.

FIG. 6A shows the rear portion of the truck bed further lowered around its central hinge to a preferred loading position.

FIG. 6B shows a higher perspective view of the truck bed at FIG. 6A.

FIG. 7 shows the rear portion of the truck bed in its travel position supported on a two-post assembly.

FIG. 7A shows the post assembly of FIG. 7 in greater detail.

FIG. 7B shows an oblique view of the truck bed in its travel position supported on the two-post assembly.

FIGS. 7C and 7D shows the latch of the post assembly in the closed and open positions.

FIGS. 8A-8D show in detail each of the elements of the two-post assembly and an elevating mechanism of an embodiment of the present invention in a step by step sequence.

FIG. 9A shows a winch carrier and winch of an embodiment of the present invention in the middle of the truck bed.

FIG. 9B shows the winch carrier and winch on the left side of the truck bed.

FIG. 9C shows the winch carrier and winch on the right side of the truck bed.

FIG. 9D shows a cross section of the winch carrier in the locked position.

FIG. 9E shows a cross section of the winch carrier in the unlocked position.

FIG. 10A shows the improved post assembly and dock lock in a travel position.

FIG. 10B shows the improved post assembly and dock lock of FIG. 10A with the rear deck of the truck bed in a lowered position.

FIG. 10C shows the post assembly and dock lock of FIG. 10A with the truck deck in an elevated position ready for loading or unloading from a commercial truck dock.

FIG. 11 shows a side view of another embodiment of the truck bed of the present invention.

FIG. 12 shows a side view of yet another embodiment of the truck bed of the present invention.

FIG. 13 shows a side view of still another embodiment of the truck bed of the present invention.

FIG. 14 shows a side view of a further embodiment of the truck bed of the present invention.

FIG. 15 shows a side view of a further embodiment of the truck bed of the present invention.

### DETAILED DESCRIPTION OF THE PRESENTLY PREFERRED EMBODIMENTS

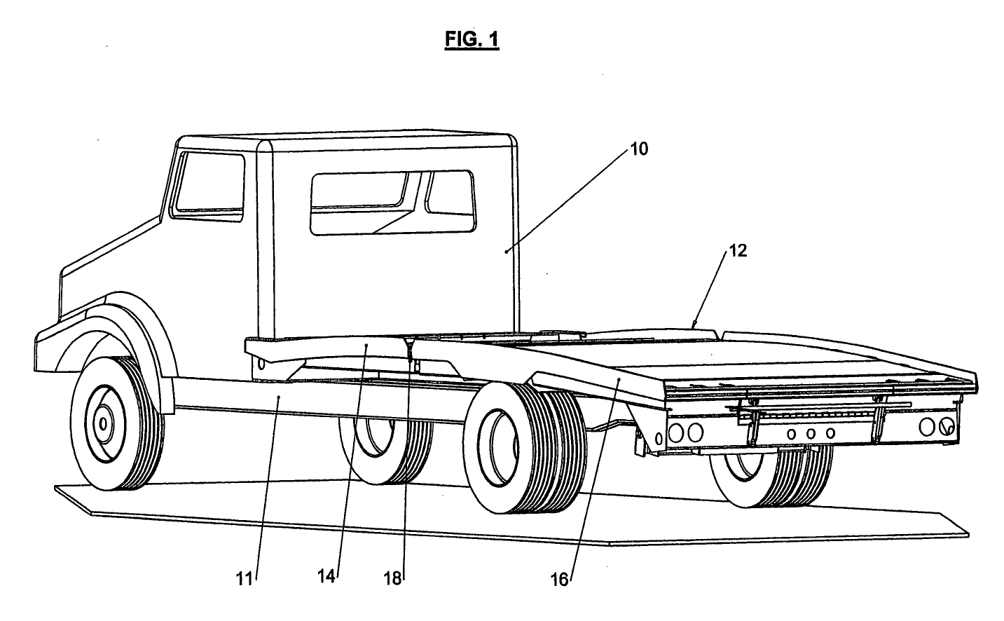

In the accompanying drawings, FIG. 1 shows an unloaded truck 10 with a truck frame 11 and a truck bed 12 of the present invention in a travel position. The truck bed 12 has a front deck portion 14 and a rear deck portion 16. In a preferred embodiment, the front deck portion 14 and the rear deck portion 16 are each constructed in the form of an arch, as shown in FIGS. 1,2, 4, 5, 6 and 7. In a further preferred embodiment, when in the travel position, the arch of the rear deck portion 16 is slightly higher than that of the front deck portion 14. A transverse hinge 18 preferably connects the front deck portion 14 and the rear deck portion 16.

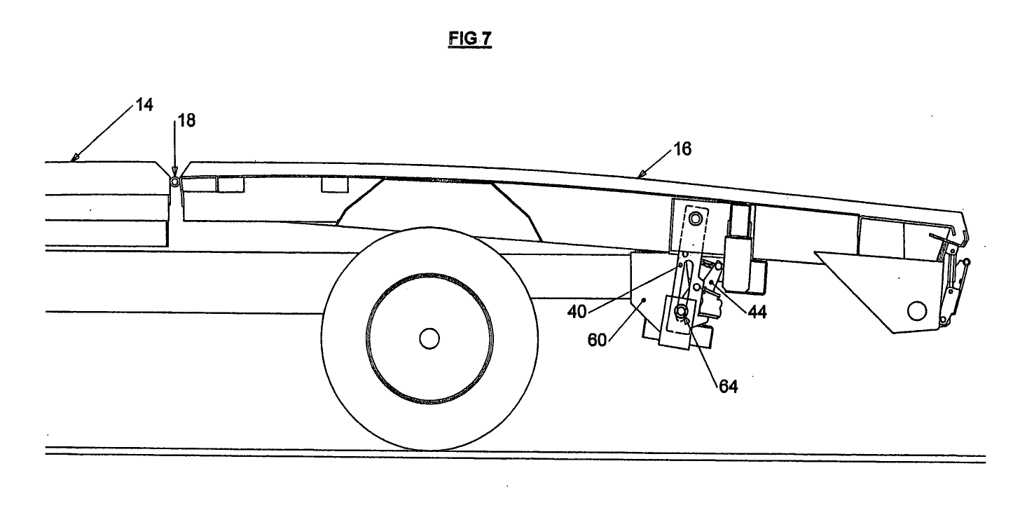

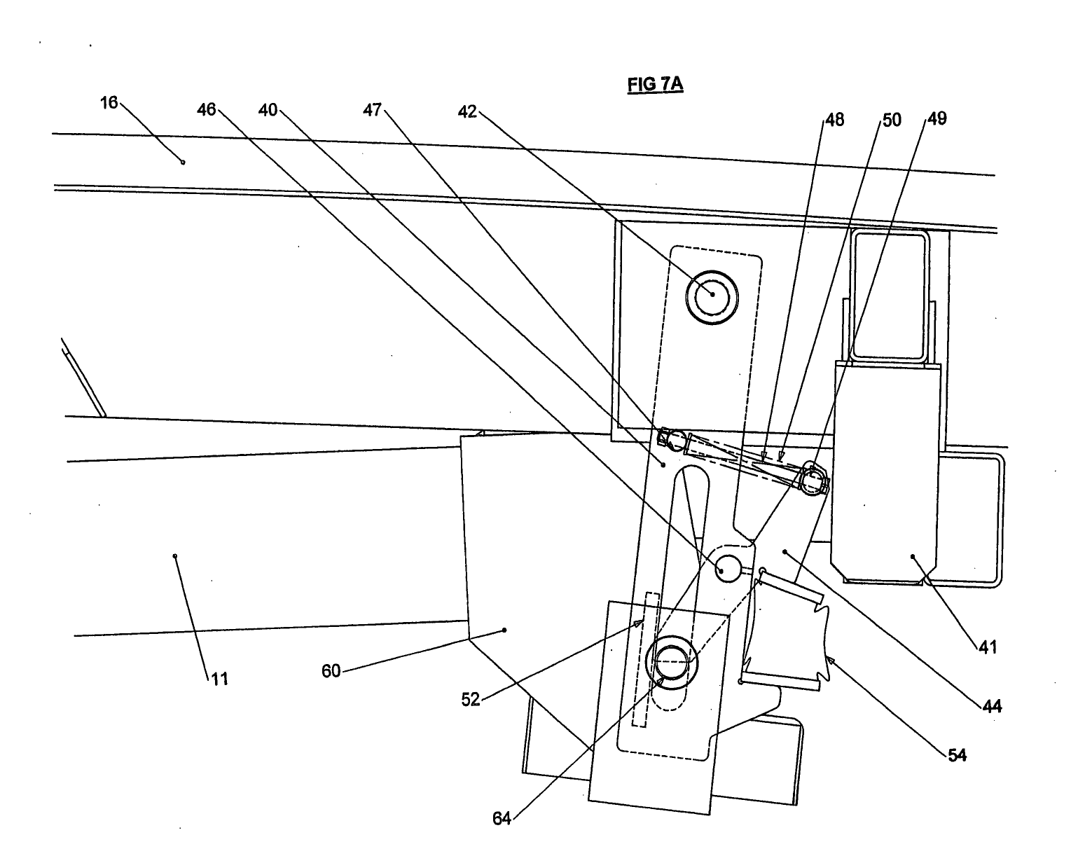

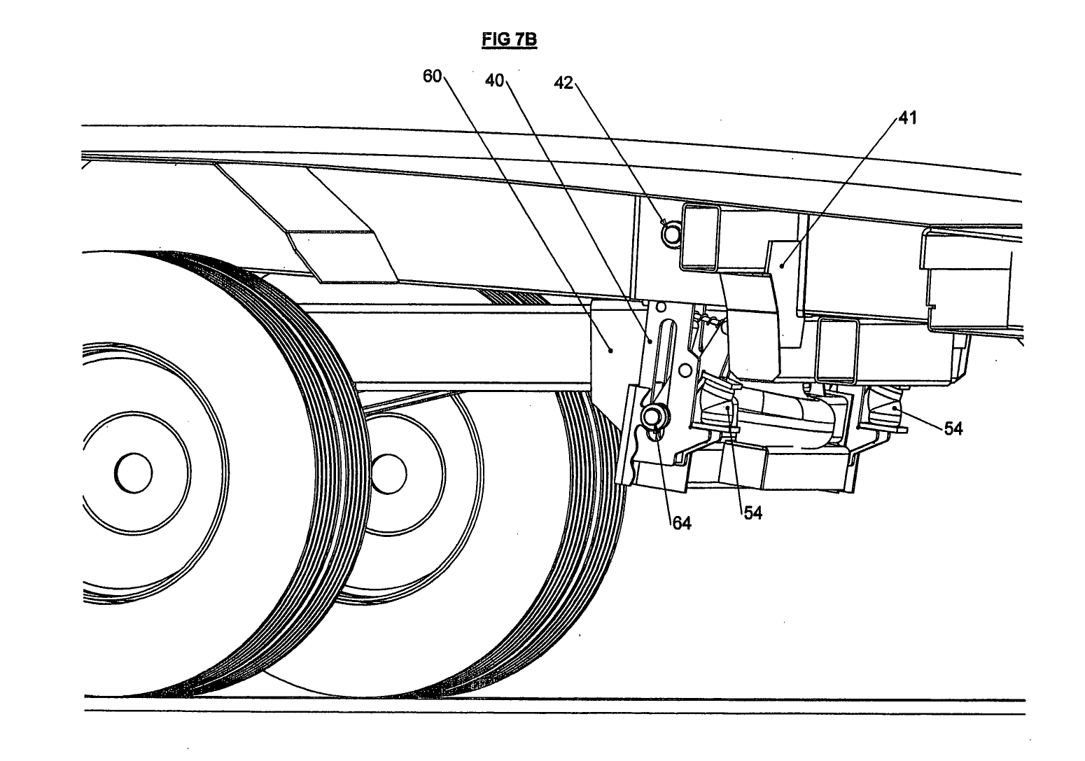

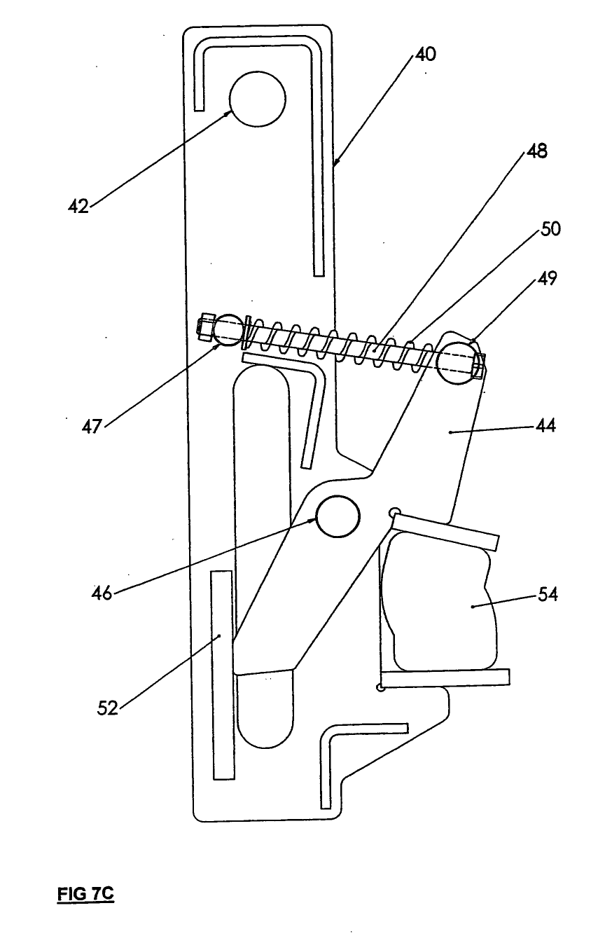

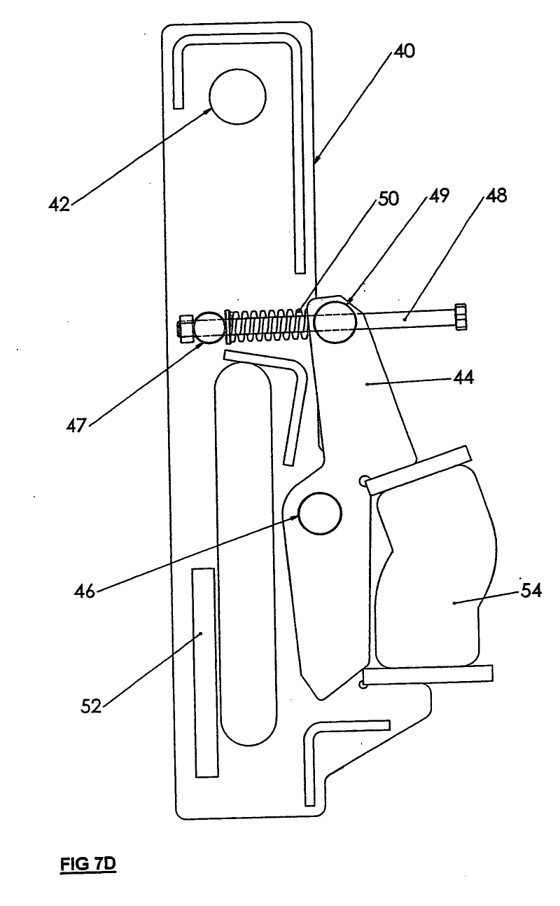

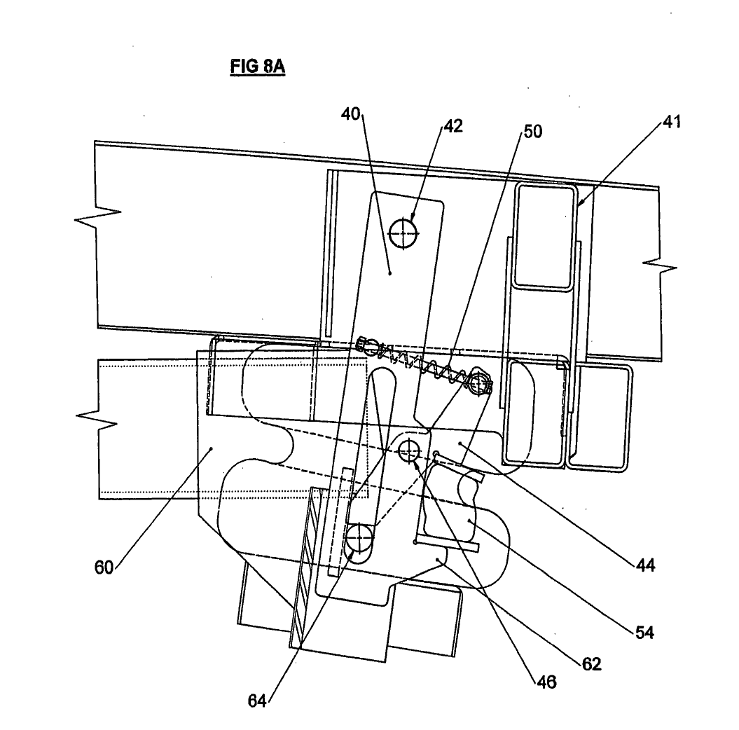

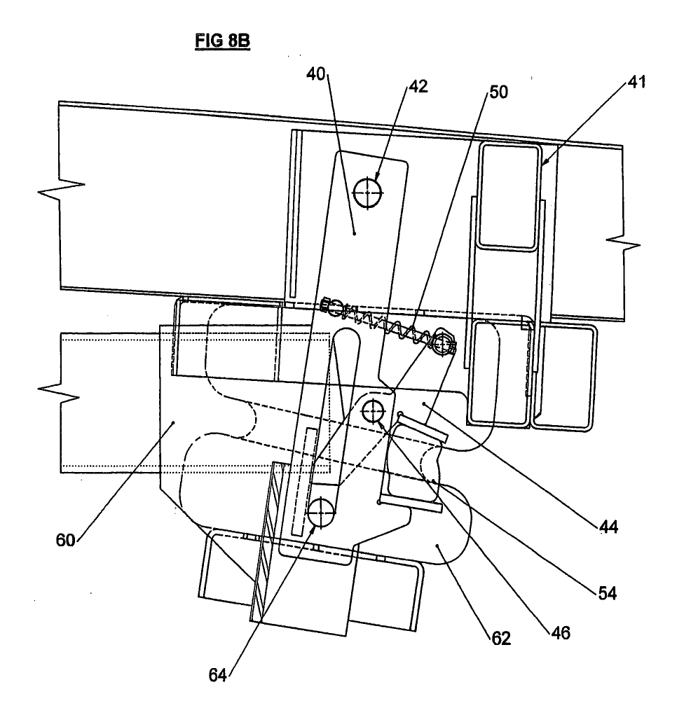

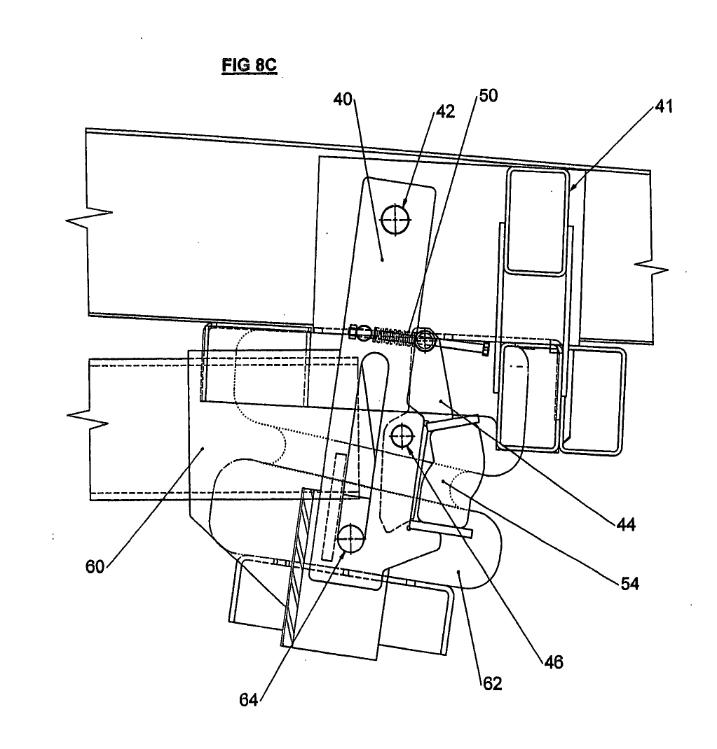

Preferably, the front deck portion 14 is firmly fixed to the truck frame 11. This connection can be made with, but is not limited to, “U” bolts and shear plates. In the travel position, the hinge mounted rear deck 16 is preferably carried on a two-post assembly 40 whose top ends are pinned to cross beam assembly 41 at 42. The closed latch 44 of the two-post assembly 40 rest on pin 64 in a frame mounted cross beam 60 shown in FIG. 7 and detailed in FIGS. 7A-7D and 8A-8D.

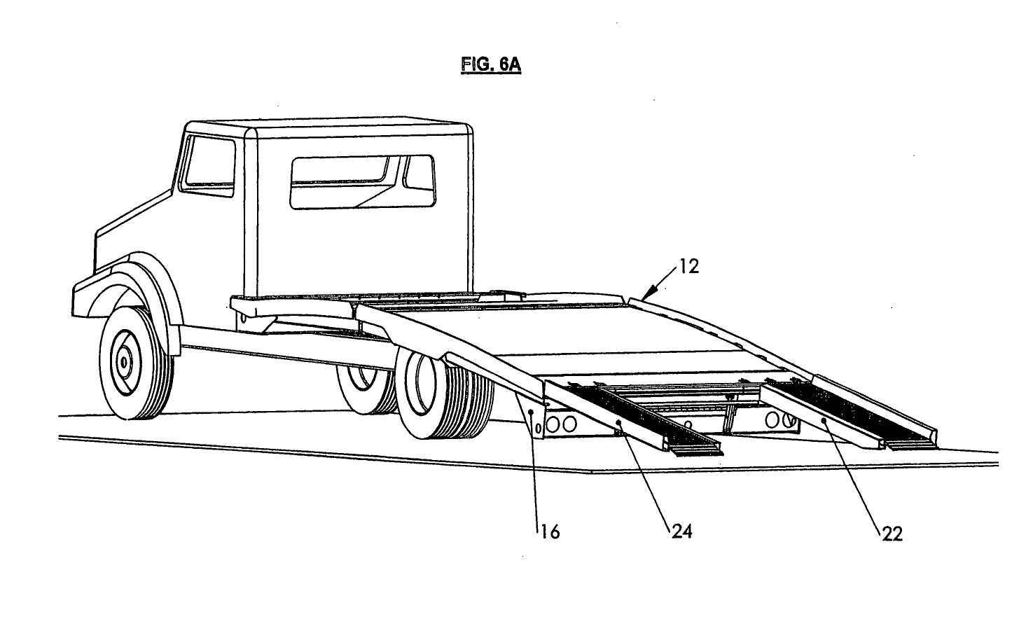

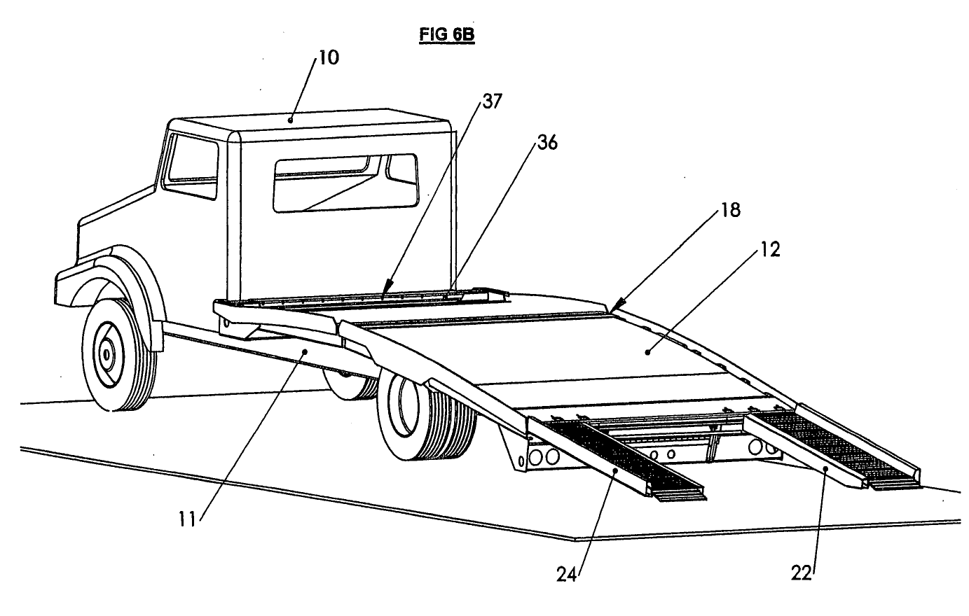

As shown in FIGS. 6A and 6B, the rear deck portion 16 can be moved through an arc about transverse hinge pin 18 by a frame mounted elevating device, such as, for example but not limited to, an air bag 62 or a hydraulic cylinder or powered screw. Preferably, the elevating device will not carry a load while the truck bed 12 is in the travel position. This is accomplished by carrying the load on the two-post assembly 40. The arc movement allows the rear deck portion 16 of truck bed 12 to be either (1) raised for loading and unloading to an elevated dock, or (2) lowered for loading and unloading directly to the ground as shown in FIGS. 6A and 6B.

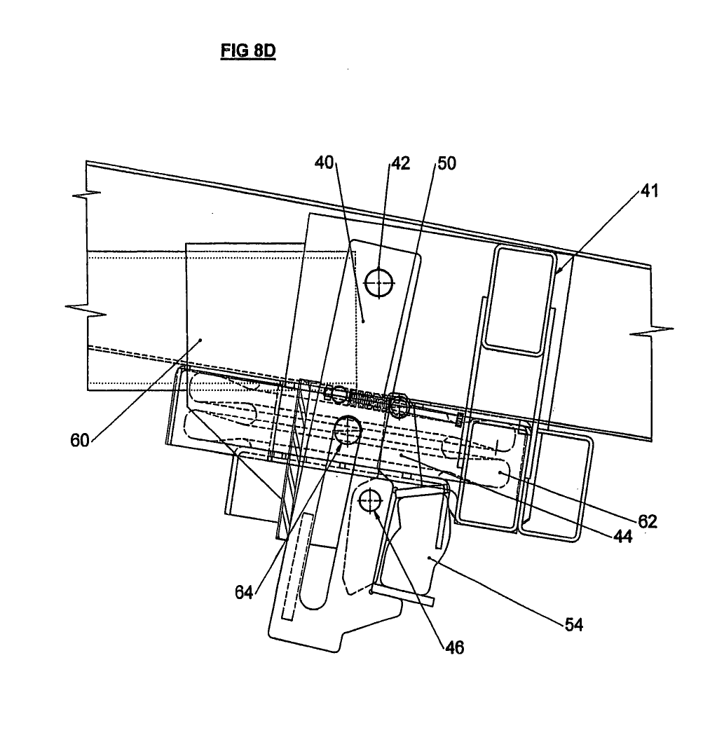

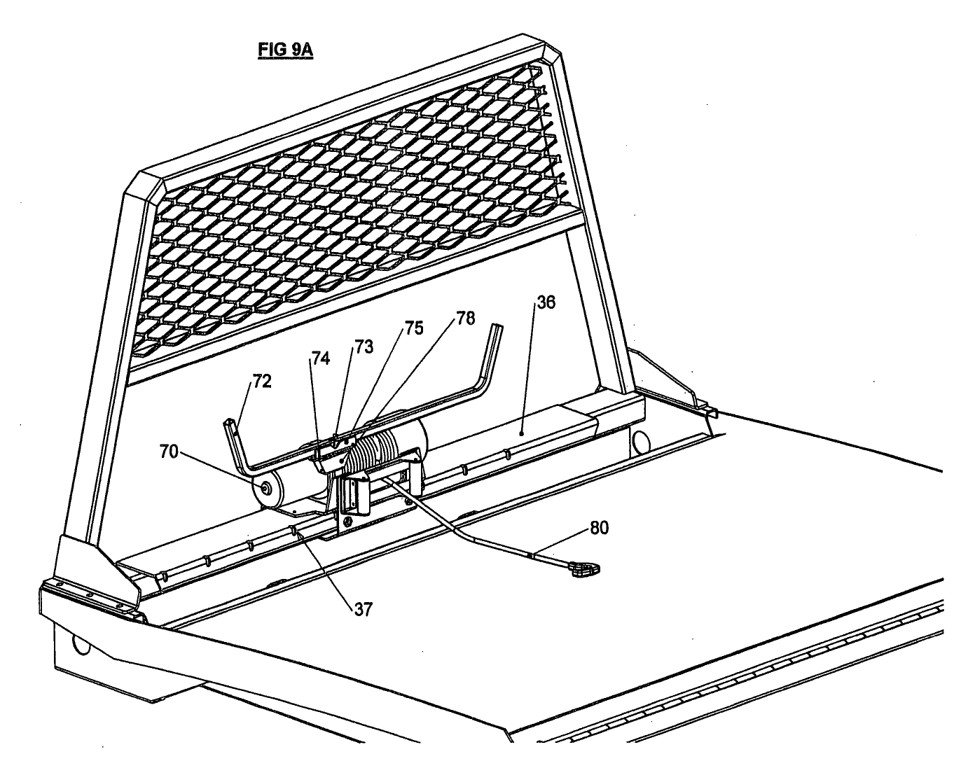

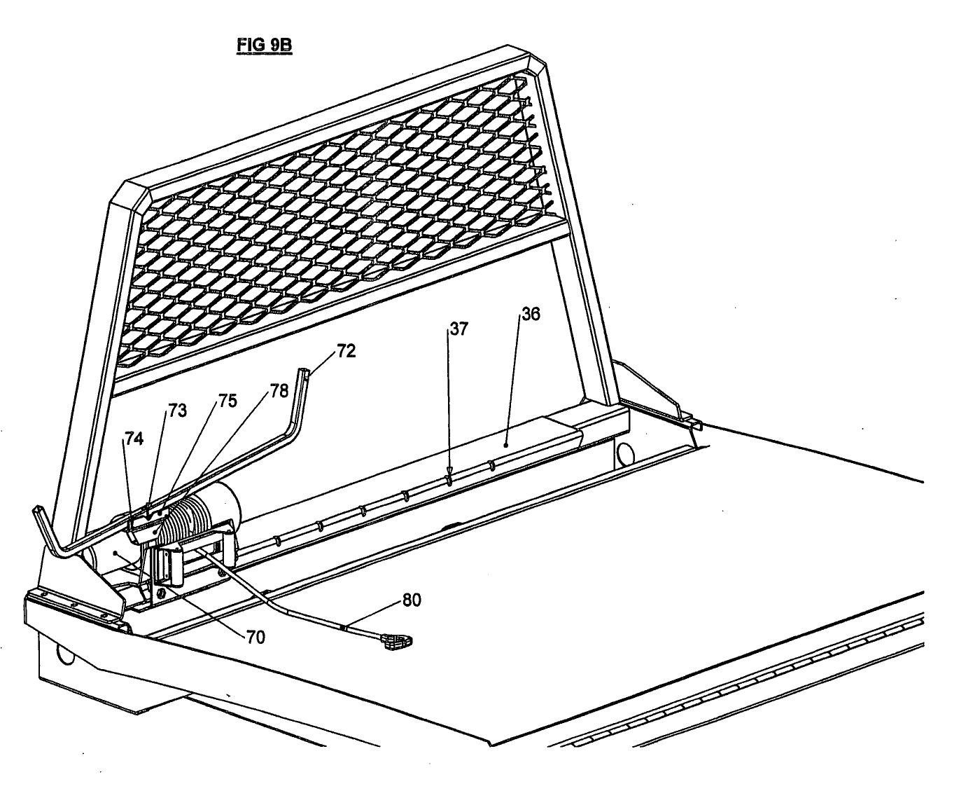

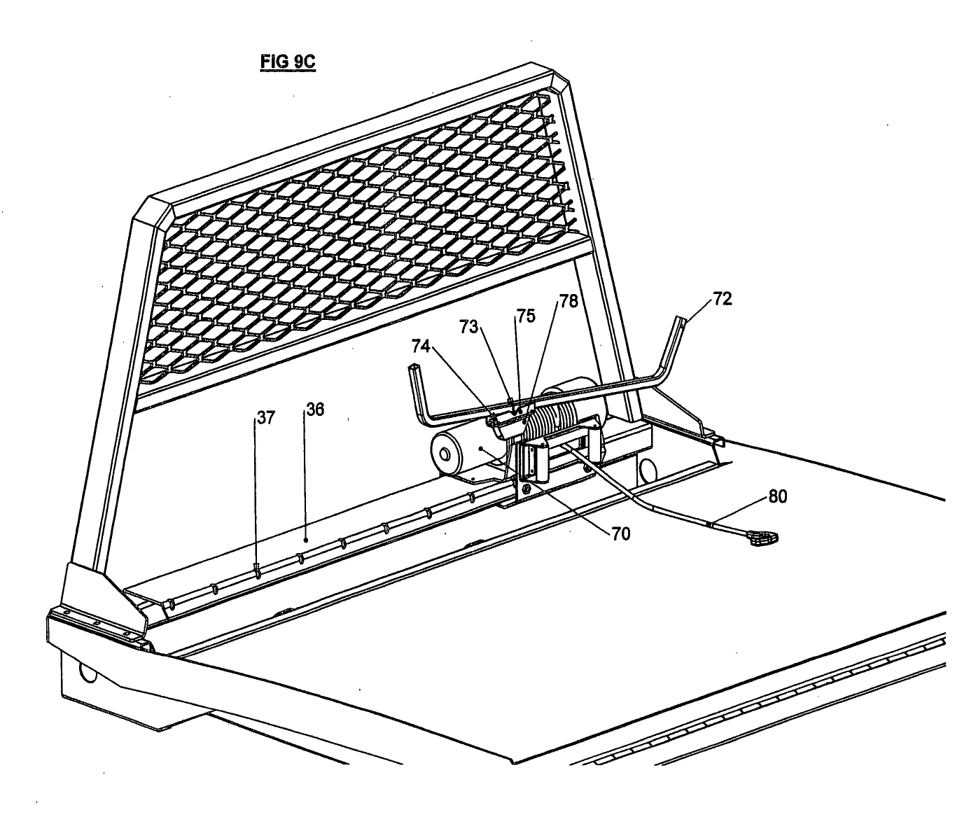

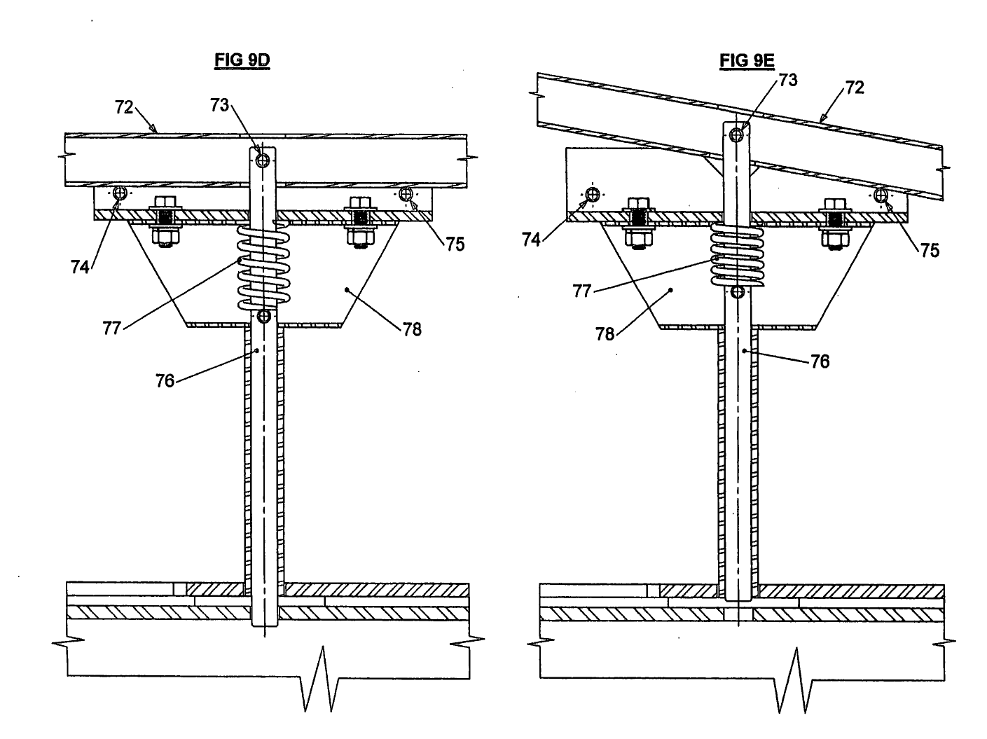

The truck bed 12 is fitted with numerous chain hold-down points across the front and back, and along both sides. An optional winch (as shown in FIGS. 9A-9E) can be fitted to the cross tube assembly (shown in FIG. 6B) at the front of the deck to assist the loading of equipment which is either unpowered or without sufficient power to climb the ramps. Preferably, the tube assembly has a number of equally spaced slots 37 along its front edge to engage a shot pin on the winch carrier for locking the winch against sideways movement when it is being used to assist in loading. This locking feature is useful when loading narrow equipment so that two or more can be loaded side by side. In those cases, the movable winch can be positioned so that it can pull each piece of equipment in a straight line. The winch can also be used with standard truck beds or in other vehicles.

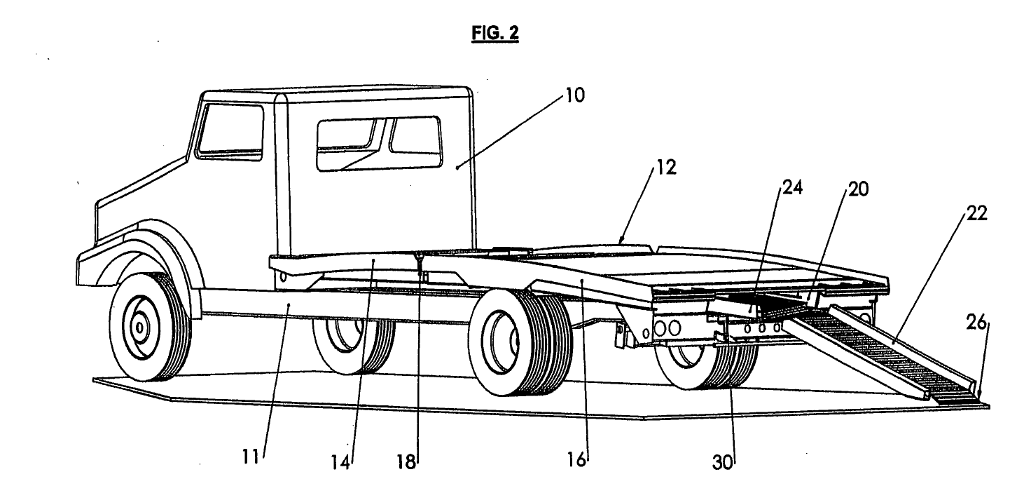

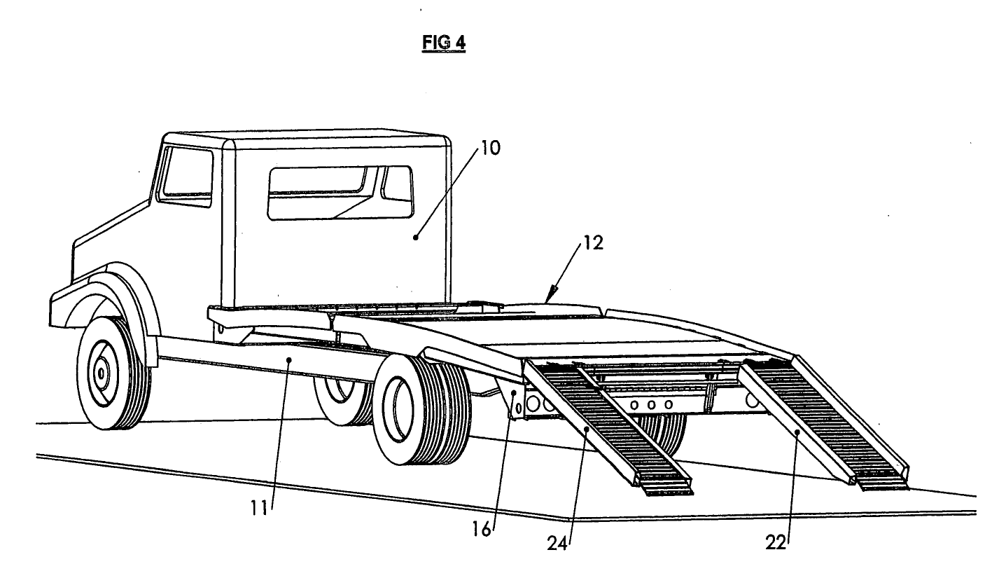

In another embodiment of the present invention, the rear deck portion 16 has a storage area 20 for storing or holding ramps. These ramps are used as a length addition to the lowered bed for ground loading and unloading. FIG. 2 shows a ramp access door 30 open with one ramp 22 out and lowered to the ground, and another ramp 24 partially removed. The ramps 22 and 24 and the deck 16 are joined when the ramp access door 30 is closed so that the ramps are locked against accidental removal, yet are free to be adjusted sideways to accommodate varying wheel widths (see FIGS. 4, 5, 6A and 6B).

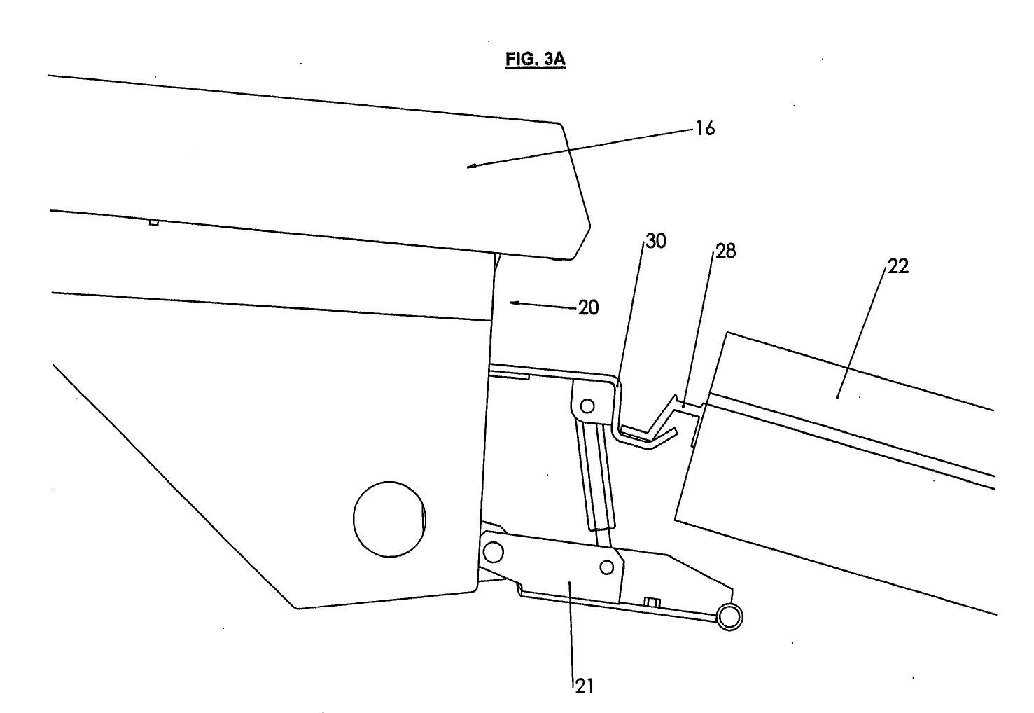

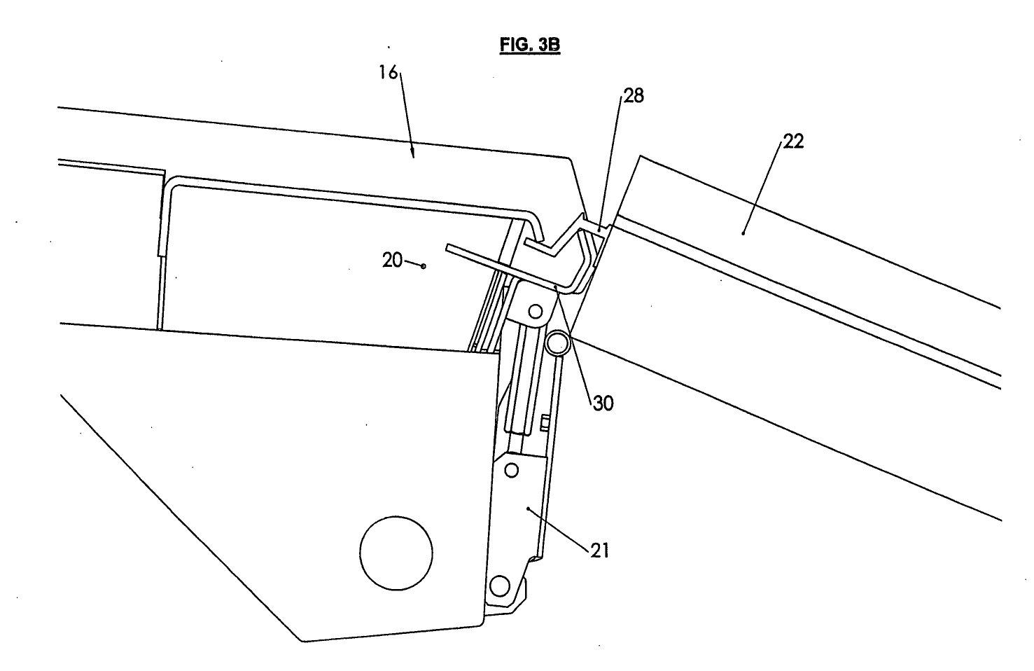

In another embodiment, the free end 26 of the ramp 22 can be grasped and pulled completely from the storage area 20 until the upper hooked end 28 of the ramp stops automatically against an upturned lip of access door 30, as shown in FIG. 3A. The free end is then lowered to the ground. When the ramps have been extracted, the access door 30 is closed by the latching mechanism 21. This effectively locks the ramps to the rear of the truck bed preventing accidental removal, yet allows them to be freely positioned laterally to accommodate varying wheel widths of the equipment that will be loaded. Preferably, the ramps are removed from their storage area 20 prior to fully lowering the rear deck portion 16 to the desired loading position as shown in FIGS. 6A and 6B. This is advantageous so as to provide room for the rear end of the truck frame 11, which will occupy part of the ramp storage area 20.

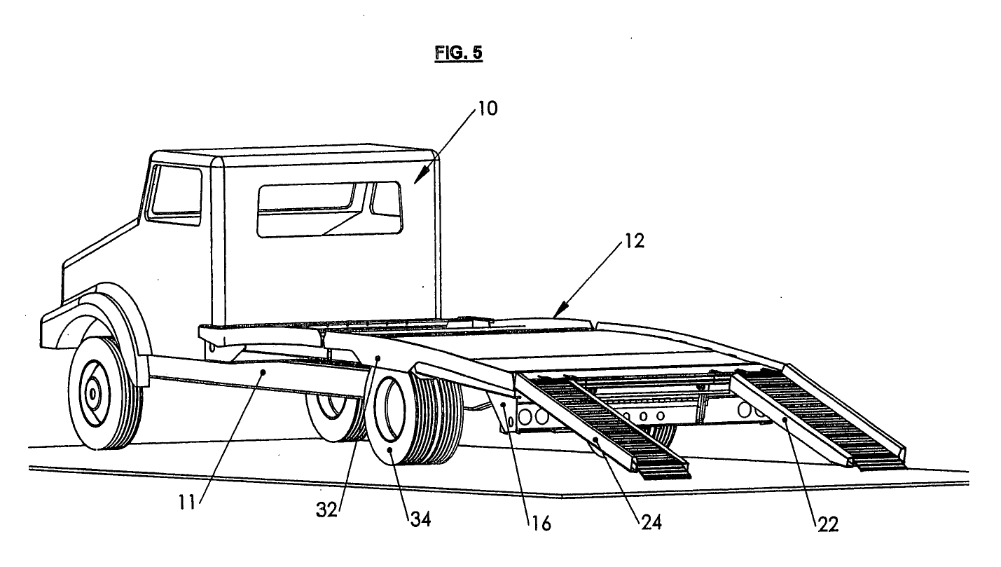

In another preferred embodiment of the present invention, the truck bed 12 is mounted on a truck 10 equipped with a rear axle air suspension. FIG. 5 shows the truck bed-ramp 32 combination in a partially lowered position wherein the air bags of the suspension have been vented, thus lowering the frame 11 at the rear axle approximately 4 to 5 inches.

FIG. 6A shows an embodiment of the truck bed 12-ramp 22 combination in a position to load equipment. In this drawing, the rear deck portion 16 has been lowered to a solid stop when the preferred air bag 62 of the frame mounted elevating apparatus has been vented. FIG. 6B shows the same view as FIG. 6A, but from a slightly higher perspective so that the transverse hinge pin 18 across the center of the bed 12 and the notched front cross tube 36 and the notches 37 are clearly shown.

In another embodiment of the present invention, the rear deck portion 16 of the truck bed 12 is held in the travel position by a two-post assembly 40 whose top ends are pinned to the deck cross beam 41 at 42, while the closed latch 44 rest on pin 64 in a truck frame cross beam 60.

Referring to FIGS. 7A, 7C and 7D, the elements of the post assembly 40 of an embodiment of the present invention are described in detail. The latch assembly 44 is pivotally mounted to post weldment by pin 46. When its operating airbag 54 is vented, it is biased to the closed position (see FIG. 7C) by spring 50 moving on rod 48 which is threaded to pin 47 and is freely axially movable through pin 49. Rotational movement of the latch 44 is stopped when its tip abuts plate 52. When the airbag 54 is inflated, the latch 44 opens by rotating around pin 46 while compressing spring 50 on rod 48 (see FIG. 7D).

FIGS. 8A through 8D are side views of the two-post assembly 40 together with the truck bed cross frame 41, the truck frame cross beam 60, and the preferred air bag elevating actuator 62. In FIG. 8A, the two-post assembly 40 is shown in the travel position with the bottom face of the latch 44 resting on frame pin 64, and with airbags 54 and 62 vented. In FIG. 8B, airbag 62 is partially inflated thus lifting the deck and the post assemblies 40 so that the bottom face of the latch 44 no longer rests on frame pin 64. In FIG. 8C, airbag 54 has been pressurized causing latch 44 to pivot on pin 46 so that its tip is rotated away from the slot in post assembly 40. In FIG. 8D, airbag 54 remains pressurized while airbag 62 is venting, allowing the rear deck portion 16 to lower fully. At this point, airbag 54 may be vented allowing latch 44 to close. When elevating the rear deck portion 16 by pressurizing airbag 62, the post assembly 40 moves upward. When the top face of the latch 44 strikes the bottom side of the frame pin 64, the latch will rotate toward its open position while staying biased against pin 64 due to the compression of spring 50. When the deck has been elevated high enough so that the bottom tip of the latch 44 has cleared the top of pin 64, it will automatically spring shut. At this point, airbag 62 is vented, thus lowering the deck to its traveling position.

A further embodiment of the present invention is directed to a winch system with a winch 70 as shown in FIG. 9A. Such a winch system can be used with the truck bed of the present invention or on other types of vehicles and truck beds and is not limited to the location shown in the figure. In FIG. 9A, the winch system is shown with the winch in a locked position in the center of the bed ready to deploy the winch cable 80 for pulling equipment up the ramps 22, 24 onto the truck bed 12 when the rear deck portion 16 has been lowered and the ramps have been deployed. Handle 72 is shown in horizontal position. As a result, the locking pin 76 (see FIGS. 9D and 9E), which is pivotally attached to handle 72 by cross point 73, is biased down into one of the notches 37 by an internal spring 77 positioned inside tube 78. This biasing action also pulls handle 72 firmly against pins 74 and 75.

FIG. 9B shows another embodiment of the winch system and winch 70 positioned along the front winch carrier tube 36 to the left of center, and locked in any of the notches 37 to prevent sideways movement while loading equipment. In practice, the handle 72 can be grasped and pulled down so that it rotates around pin 74 thus pulling the locking pin 76 from notch 37 freeing the winch carrier for movement to the left.

FIG. 9C shows another embodiment of the winch system wherein the winch is positioned to the right of center.

FIGS. 9D and 9E show the relationship of the details of the handle 72, cross pin 73, pins 74 and 75, locking pin 76, spring 77, and tube 78.

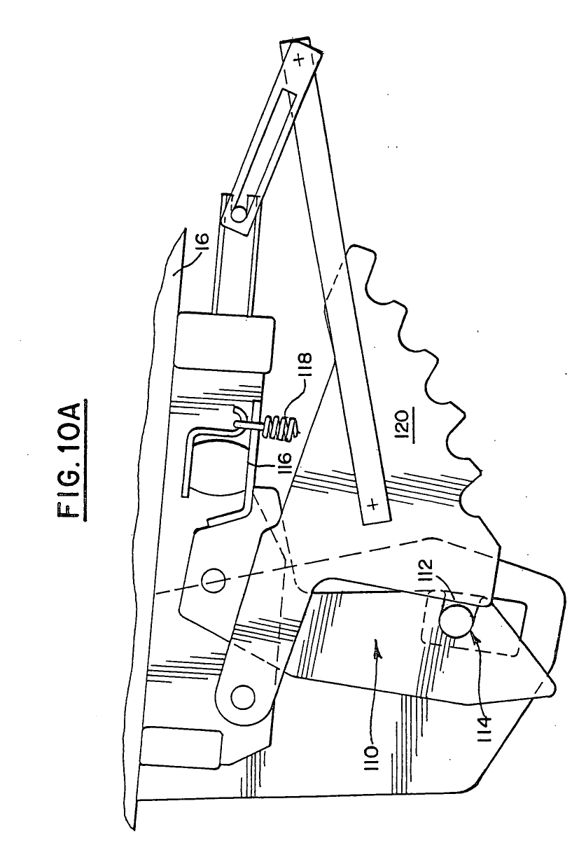

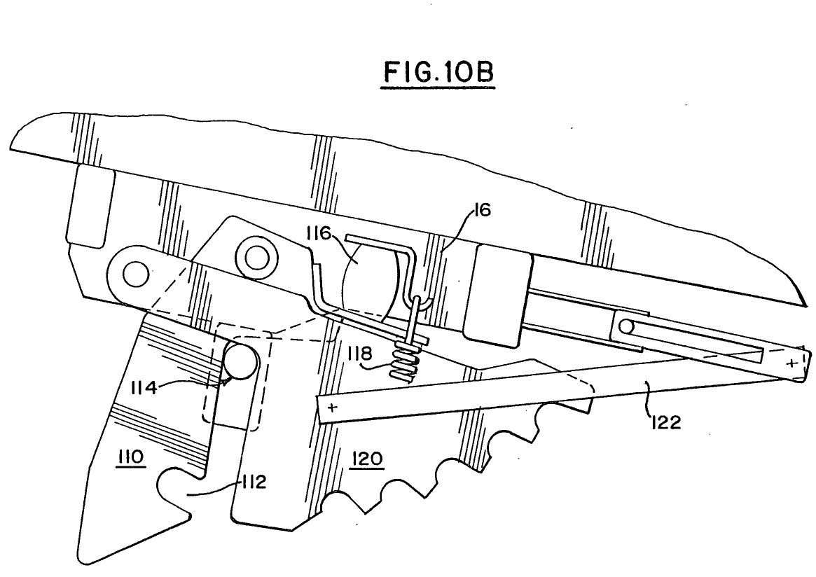

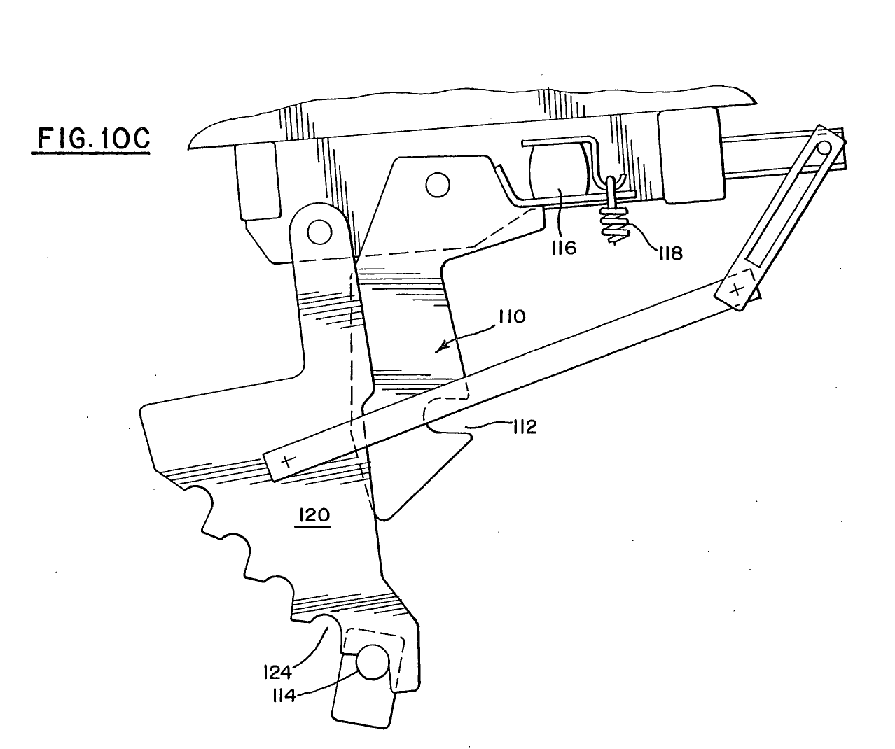

FIGS. 10A-10C illustrated a further embodiment of the present invention. This embodiment is directed to an improved locking post or post assembly which replaces the post assemblies 40 in the prior embodiments. This embodiment will still include the main airbag 62 (not shown in FIGS. 10A-10C) for raising and lowering the truck bed. One or more of these post assemblies can be located at the rear of a truck.

FIG. 10A illustrates the improved post assembly 110 when the rear deck portion 16 of the truck bed is in a travel position. Post assembly 110 includes a groove or notch 112 located at the lower end of the locking post. When in the travel position, notch 112 is fit around a locking pin 114 which is attached to the truck frame. An air bag 116 and spring 118 are also shown in FIG. 10A. Post assembly 110 is biased shut on locking pin 114 by spring 118. Further, as shown in FIG. 10B, air bag 116 is used for pushing post assembly 110 away from locking pin 114 when it is desired to lower the rear deck, e.g. for unloading or loading something onto the truck bed. Dock lock 120 is shown in the stored position in this figure.

FIG. 10B illustrates the post assembly of FIG. 10A when the rear deck 16 is in the lowered position. In this position, air bag 116 causes post assembly 110 to swing away from locking pin 114 to free the rear deck so it can be lowered. Locking pin 114 then moves out of notch 112 and slides upward as deck 16 is lowered. As shown in FIG. 10B, dock lock 120 is held in place by a spring biased linkage 122

FIG. 10C illustrates the rear deck portion 16 being raised to height for loading or unloading from a commercial truck dock. To elevate the deck, post assembly 110 is swung loose from locking pin 114 in the same manner as described above for FIG. 10B. The main airbag (62 in prior figures) is further inflated causing rear deck portion 16 to rotate upward. Linkage 122 holding dock lock 120 is released, allowing dock lock 120 to rotate down against locking pin 114. In practice, preferably rear deck portion 16 is rotated upward until its rear edge is slightly above the level of the dock. Pressure in the main airbag is released, allowing the appropriate notch 124 to engage locking pin 114, and thus firmly holding the rear deck at or near dock height, in a ready position for loading or unloading the truck. To return the rear deck from dock height to a travel position, the main airbag is inflated enough to free dock lock 120 from locking pin 114. Dock lock 120 is then rotated into travel position by linkage 122. The main airbag is vented allowing the rear deck to rotate downward. The angled surface of post assembly 110 below notch 112 encounters locking pin 114, causing the locking post to swing back under spring pressure. As notch 112 comes in line with locking pin 114, post assembly 110 swings shut under spring pressure, thus locking the rear deck in its travel position.

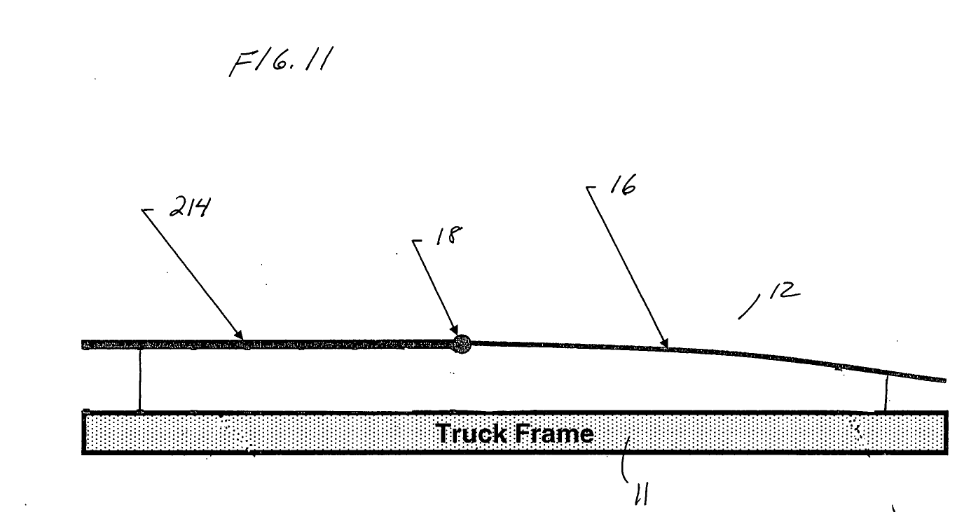

FIGS. 11-15 show side views of further embodiments and alternatives for the truck bed 12 of the present invention. These embodiments can be used with truck 10, truck frame 11, post assemblies, ramps, winches, etc. which are discussed supra for the prior embodiments. They can further be used on a vehicle such as a trailer, especially but not restricted to a construction equipment trailer.

FIG. 11 shows a further embodiment of the truck bed 12 of the prior figures of the present invention. In this embodiment, a substantially flat front deck portion 214 is substituted for front deck portion 14. Front deck portion 214 is preferably firmly fixed to the truck frame 11, or to a vehicle frame. A transverse hinge pin 18 preferably connects the front deck portion 214 and the rear deck portion 16. Rear deck portion 16 can be similar to the same element described above.

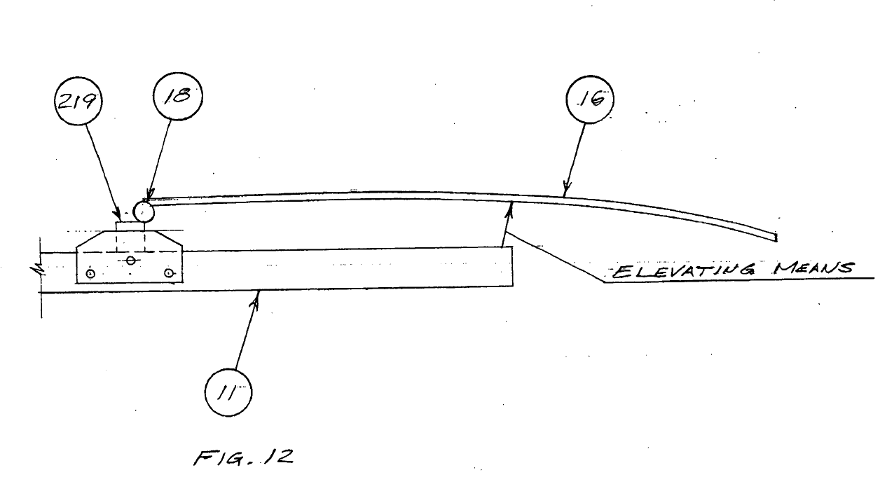

FIG. 12 is an alternate embodiment of the present invention directed to the pivot hinge pin 18 associated with the rear deck portion 16. In this embodiment, preferably, cross beam hinge support 219 is firmly fastened to truck frame 11, or to a vehicle frame. Preferably a transverse hinge pin 18 connects the rear deck portion 16 to the cross beam hinge support 219 so that the rear deck portion arches towards the area above the hinge pin 18 and cross beam hinge support 219 creating a continuous convex curve over said truck frame 11, or vehicle frame.

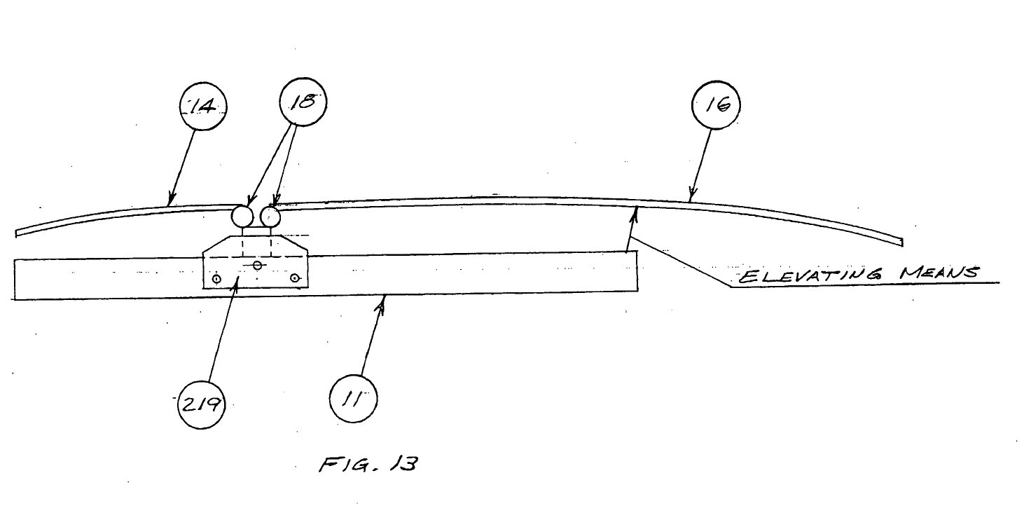

The embodiment of FIG. 13 is similar to the embodiment of FIG. 12 but each of the front deck portion 14 and the rear deck portion 16 are connected to cross beam hinge support 219 by transverse hinge pins 18 so that they arch upward towards the area above the hinge pins 18 and cross beam hinge support 219 thus forming a continuous convex curve over said truck frame 11, or vehicle frame.

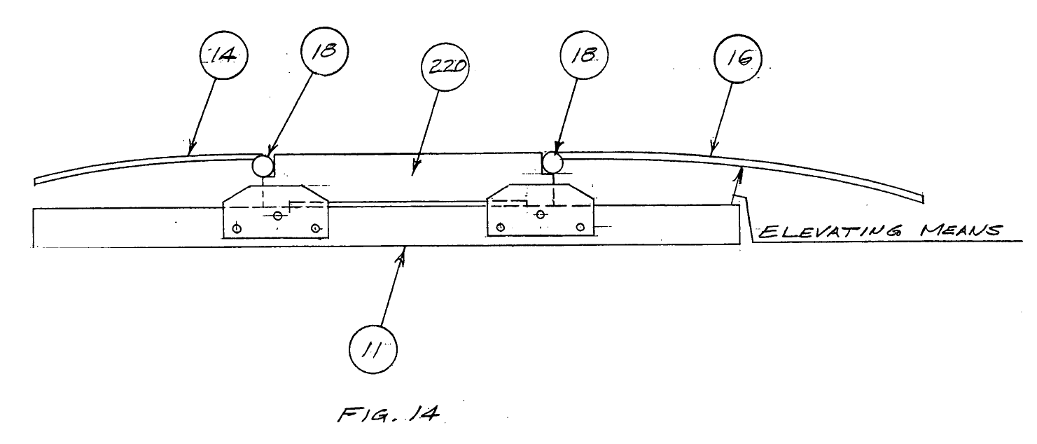

FIG. 14 is a further embodiment of the truck or vehicle bed of FIG. 13 wherein a deck extension panel 220 with supports for hinges is substituted for cross beam hinge support 219, and is firmly fastened to truck frame 11 or vehicle frame. Front deck portion 14 and rear deck portion 16 are connected to deck extension panel 220 by transverse hinge pins 18 thus forming an extended bed wherein front deck portion 14, and rear deck portion 16 arch upward toward the area above the hinge pins 18, and the deck extension panel 220.

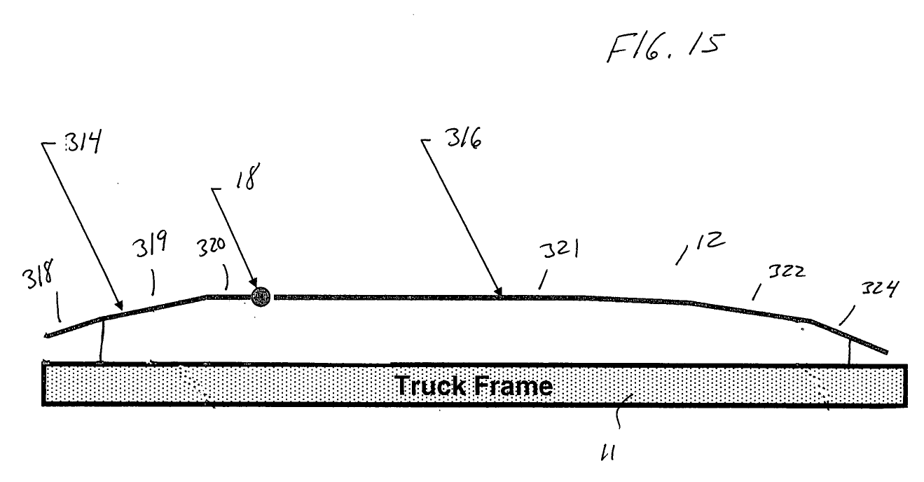

FIG. 15 is another embodiment of the present invention wherein truck bed 12 includes front deck portion 314 and rear deck portion 316 whose deck surfaces have been formed by a series of small angular bends (e.g. 318-322) so as to approximate the continuous convex shape of front deck portion 14 and rear deck portion 16. In a preferred embodiment, at least 3 angular segments are used to approximate the continuous convex shape over the frame.

This description has been offered for illustrative purposes only and is not intended to limit the invention of this application which is defined in the claims below.

1. A truck or vehicle comprising:
a frame; and
a bed located on said frame, said bed comprising:
a substantially flat front deck portion;
a rear deck portion; and
a hinge connecting said substantially flat front deck portion and said rear deck portion, wherein said rear deck portion arches upward toward said hinge, so that said rear deck portion has a continuous convex curve shape over said frame.

2. A truck or vehicle comprising:
a frame; and
a bed located on said frame, said bed comprising:
a cross beam hinge support fastened to said frame a pivot/hinge;
a rear deck portion; and
a pivot pin connecting said rear deck portion to said cross beam hinge support.

3. The truck or vehicle of claim 2 wherein said rear deck portion arches upward toward said pivot/hinge area, so that said bed has a continuous convex curve shape over said frame.

4. A truck or vehicle comprising:
a frame; and
a bed located on said frame, said bed comprising:
a front deck portion;
a cross frame hinge support;
pivot/hinges;
a rear deck portion; and
hinge pins connecting said front deck portion and rear deck portion to said cross frame hinge support,
wherein each of said front deck portion and said rear deck portion arches upward toward area above said cross frame hinge support, so that said bed has a continuous convex curve shape over said frame.

5. A truck or vehicle comprising:
a frame; and
a bed located on said frame, said bed comprising:
a front deck portion;
a deck extension panel:
pivot/hinge supports;
a rear deck portion;
hinge pins connecting said front deck portion and rear deck portion to said deck extension panel

6. The truck or vehicle of claim 5 wherein each of said front bed portion and said rear bed portion arches upward toward said deck extension panel, so that said front and rear bed has a continuous convex curve shape over said frame.

7. A truck comprising:
a frame; and
a bed located on said frame, said bed comprising:
a front deck portion;
a rear deck portion; and
a hinge connecting said front deck portion and said rear deck portion,
wherein each of said front deck portion and said rear deck portion angles upward toward said hinge, so that said front and rear bed portion has a series of angular segments to approximate a continuous convex curve shape over said frame.

8. The truck of claim 7 wherein said series of angular segments comprises at least 3 angular segments.
